(19) United States
(12) Patent Application Publication
(10) Pub. No.: US 2012/0279813 A1
(43) Pub. Date: Nov. 8, 2012

(54) WHEEL ASSEMBLY

(75) Inventor: Guido Kochsiek, Leopoldshoehe (DE)

(73) Assignee: IPROTEC MASCHINEN- UND EDELSTAHLPRODUKTE GMBH, Petershagen-Friedewalde (DE)

(21) Appl. No.: 13/512,455

(22) PCT Filed: Nov. 27, 2010
(86) PCT No.: PCT/EP2010/007202

§ 371 Date: Jul. 25, 2012

(30) Foreign Application Priority Data
Nov. 30, 2009 (DE) 10 2009 056 075.0

(51) Int. Cl. F16D 55/00

(52) U.S. Cl. 188/71.1

(57) ABSTRACT

The invention relates to a wheel assembly of a motor vehicle, in particular a passenger car, having a brake disc (3) received by a wheel axle (2) so as to be fixed against rotation and a brake caliper (4) that interacts with the latter and, constructed as a fixed caliper, is arranged on a wheel carrier (5) so as to be fixed with respect to the brake disc (3). The brake disc (3) is carried by the wheel axle (2) such that it is relatively displaceable with respect to the brake caliper (4) in the longitudinal direction (9) of the wheel axle (2).

### CROSS-REFERENCE TO RELATED APPLICATIONS

This application is a National Stage of International Application No. PCT/EP2010/007202, filed Nov. 27, 2010, and published in German as WO 2011/069606 A1 on Jun. 16, 2011. This application claims the benefit and priority of German Application No. 10 2009 056 075.0, filed Nov. 30, 2009. The entire disclosures of the above applications are incorporated herein by reference.

### BACKGROUND

This section provides background information related to the present disclosure which is not necessarily prior art.

### TECHNICAL FIELD

The invention relates to a wheel assembly for a wheel of a motor vehicle, in particular for the wheel of a passenger car, with a brake disc received by a wheel axle so as to be fixed against rotation and a brake caliper that interacts with the latter, which is constructed as a fixed caliper and arranged on a wheel carrier so as to be fixed with respect to the brake disc, as well as a wheel.

### Discussion

Because wheel assemblies with brake assemblies for motor vehicles in general as well as brake disk assemblies for motor vehicles in particular are known in the art, no separate publications must at this juncture be cited as evidence.

Wheel assemblies encompass a wheel, which is driven by a drive shaft, which usually originates from a gearbox. The wheel is mounted in a pressing carrier, which in turn is mounted in corresponding suspensions. A co-rotating brake disc is turned relative to a rotationally fixed brake caliper. As a rule, the brake caliper exhibits hydraulically actuated brake elements, which are suitable and provided for slowing down the brake disc, and hence the wheel.

A brake disc assembly of the previously known type has a brake disc on the one hand, and a brake caliper on the other, which interact in the braking process. The brake disc is here coupled with the wheel axle so as to be fixed against rotation, and co-rotates with the latter. By contrast, the brake caliper is fixed in place, and arranged on a wheel body.

A conventional brake caliper has at least one piston-actuated abrasive agent carrier, which while braking as intended, is pressed against the surface of the brake disc provided for this purpose. Also known from prior art are those structures that use two abrasive agent carriers, which act on the brake disc in response to an intended load, i.e., braking process, so that the one abrasive agent carrier is pressed against the one side of the brake disc, and the other abrasive agent carrier is pressed against the other side of the brake disc. For example, the brake disc can be a ventilated brake disc.

As a result of abrasion, wear marks arise in a brake disc assembly even during proper use, specifically affecting both the brake disc and abrasive agent carrier of the brake caliper. In the brake disc assemblies known from prior art, this abrasion-induced wear is offset by having the piston-loaded abrasive agent carrier of the brake caliper follow behind. This makes it possible to compensate for abrasion to both the brake disc, as well as to the abrasive agent carriers of the brake caliper.

Even though previously known brake disc assemblies have proven themselves in day-to-day use, there is need for improvement, in particular with an eye toward optimizing the braking effect even given abrasion to the brake disc and/or abrasive agent carrier.

In addition, previously known wheel assemblies are still comparatively heavy. Since the wheel can be steered, the wheel carrier is arranged on a corresponding steering assembly. Aside from abrasion to the brake assembly on the one hand, the numerous required individual elements yield an unnecessary weight on the other. For example, an imbalance must also be offset, which is why the brake caliper is normally situated on highly complex assemblies that allow the brake caliper to float relative to the disc. Constant temperature changes, i.e., from heating to incandescence or use in extremely cold conditions, mechanical impacts and the like lead to mismatches between the disc and brake caliper, or special loads on the brake caliper, so that elaborate structures must be fabricated for the suspensions accommodating the brake calipers that usually float on the disc. Weight is here added yet again. One very special aspect of such assemblies involves the so-called comfort level. This is understood to mean the little or no noise associated with foregoing the use of jerky approaches and the like.

### SUMMARY OF THE INVENTION

Proceeding from the prior art described above, an object of the present invention is to provide a wheel assembly that can be made out of a few parts and also save on weight, provides an improved braking effect even if the brake disc and/or central wheel beam have been worn by abrasion, and enables a simplified overall assembly.

The brake disc according to the brake disk assembly described in the invention is designed so that it can shift in the longitudinal direction of the wheel axle carrying it. This allows the brake disc to shift in the longitudinal direction of the wheel axle relative to the brake caliper, and hence also relative to the abrasive agent carriers provided by the brake caliper. As a consequence, abrasive wear to the abrasive agent carriers and/or brake disc can be counteracted by moving up the brake disc, since it is advantageously ensured that the brake disc is always optimally aligned in terms of its position relative to the brake caliper with respect to the longitudinal extension in the direction of the wheel axle. This ability of the brake disc to shift longitudinally as provided by the invention proves advantageous in particular for brake calipers that act on either side of the brake disc, i.e., exhibit piston-loaded abrasive agent carriers on both sides of the brake disc.

In structures known from prior art, varying wear on the front and rear sides of a brake disc or the abrasive agent carriers respectively allocated to these sides may cause the brake disc to become positioned relative to the abrasive agent carriers provided on either side of the brake disc in such a way as to detract from the braking effect. The structure according to the invention here provides for a remedy in an advantageous fashion, since the brake disc is designed to shift in the longitudinal direction of the wheel axle, thereby ensuring that the brake disc adjusts itself, and is always aligned in an optimized position relative to the abrasive agent carriers furnished on the front and rear sides of the brake disc.

In addition, the structure according to the invention also brings with it the advantage that no thermal delay comes about during application, i.e., while braking, due to an uneven load on the front and rear sides of the brake disc. Since the brake disc always positions itself in relation to the abrasive agent carriers of the brake caliper, it is assured that the latter will act uniformly on the brake disc, so that the same force effect arises on both the front and rear sides of the brake disc.

Because it is mounted so that it can longitudinally shift relative to the fixed brake caliper, the brake disc provided with the structure according to the invention can also be referred to as a floating brake disc. By virtue of its floating design, the latter makes it possible to adjust the wear, and further ensures a uniform thermal load while braking, which improves the overall braking effect. In addition, the uniform load while braking makes it possible to avoid the disadvantageous “umbrella effect”, i.e., a bulging or blistering of the brake disc, that arises in brake assemblies according to prior art. This yields an improved overall braking effect, even in the case of wear. For example, the so-called umbrella effect can be caused by very strong braking processes, e.g., emergency brake applications. In prior art, an uneven torque is transferred from the brake contact surfaces to the bearing. This stems from the fact that a flat disc is as a rule reinforced from one side, interspersing vent lamellae in the friction surface area. As a result, the torques will be absorbed very unevenly on both disc sides, with torsional moments even arising within the brake disc on their own. Since this does not happen in the discs according to the invention, with a uniform load and bilaterally identical absorption of torques here taking place instead, vent webs can be given a very thin design, which saves on weight, and the disc can be optimally ventilated.

While it is known to provide the friction surfaces of brake discs with holes or grooves, for example to channel away dirt, moisture and the like, the invention proposes that the friction surfaces be furnished with irregular polygonal lines. The latter induce weight-reducing material removal, make it possible to controllably guide moisture, water and dirt, and can be fabricated at a low economic outlay.

In order to join the brake disc and wheel axle together in such a way as to fix them against rotation, another feature of the invention provides for a connecting part. The latter positively engages both the brake disc and wheel axle, so that a twisting motion of the wheel axle can be conveyed via the connecting part to the brake disc. The positive connection between the connecting part on the one hand and wheel axle on the other is here configured in such a way that, in addition to coupling the brake disc and wheel axle so as to fix them against rotation, the brake disc can be shifted relative to the wheel axle in the longitudinal direction of the wheel axle. Because of its positive fit, the connecting part that positively engages both the brake disc and wheel axle here permits only a transmission of torque, i.e., momentum, but not a transmission of force in the longitudinal direction of the drive axle.

In another feature of the invention, the connecting part exhibits a borehole with an inner contour correspondingly designed relative to the cross sectional contour of the wheel axle. In the sense described above, this configuration enables a transfer of torque, i.e., momentum, proceeding from the wheel axle to the brake disc, specifically with the brake disc simultaneously being able to longitudinally shift relative to the wheel axle. The cross sectional contour of the wheel axle and inner contour of the borehole of the connecting part are most preferably polygonal in design.

Within the meaning of the present invention, polygonal basically encompasses any cross section that deviates from the pure circular shape. Such irregular cross sections can be fabricated based on new types of noncircular turning technologies. The configuration can be tailored to the respective application in virtually any way desired.

In another feature of the invention, the connecting part is disk-shaped, wherein the connecting part exhibits a thickness exceeding the thickness of the brake disc in the longitudinal direction of the wheel axle. This configuration makes it possible to longitudinally shift the brake disc to a defined extent in the longitudinal direction of the wheel axle relative to the wheel axle, the connecting part and the brake caliper fixed in place in relation to the wheel axle.

The configuration described above proves advantageous for a multiplicity of reasons. The ability of the connecting part to shift longitudinally relative to the wheel axle permits easy assembly, since a central locking device can be used. For purposes of assembly and disassembly, the connecting part can easily be attached to the drive axle, and fixed in place in the desired position relative to the drive axle, for example by means of a central locking device. After the connecting part has been slipped or clipped onto the drive shaft and subsequently fixed in place, the connecting part is prevented from undesirably shifting relative to the wheel axle in the longitudinal direction of the latter. Apart from that, the polygonal intermeshing geometric design for the inner borehole of the connecting part on the one hand, and outer contour of the wheel axle on the other ensures a torsion-free connection between these two structural components.

The brake disc can now be joined, i.e., coupled, with the wheel axle in what is also a simple assembly step. The positive connection between the connecting part on the one hand and brake disc on the other ensures that the brake disc is fixed against rotation relative to the wheel axle, but can simultaneously shift longitudinally in relation to the latter, so that, in the sense described above, the brake disc can be readjusted vis-à-vis the wheel axle, and hence the brake caliper that is fixed relative to the wheel axle.

The most preferably disk-shaped connecting part has an inner ring and an outer ring, which are joined together via corresponding webs. According to another feature of the invention, the outer ring here bears outwardly projecting extensions, which when assembled at least partially engage positively into recesses formed on the brake disc. This configuration makes it possible to join the connecting part on the one hand with the brake disc on the other so as to be fixed against rotation, as already described above, but at the same time also allows the brake disc to shift relative to the connecting part in the longitudinal direction of the wheel axle.

The connecting part is formed by individual segments, for example comprised of aluminum, which for their part exert a filtering effect. The connection is established by inserting pin elements into corresponding boreholes. The aluminum elements exhibit a spring action, and the pins are used pretensioned in cold conditions. Since the friction surface area of the brake disc is made out of steel, or also cast iron, for example, but the connecting part consists of aluminum, both have a varying heat exchange coefficient, and thus each act differently during operation. This increases the pretension, so that no clearance sets in, as opposed to the corresponding systems known from prior art. While clearance usually comes about between the elements in prior art due to arising heat and expansion, the structural design according to the invention advantageously yields an improved fixation.

The extensions of the outer ring are most preferably aligned polygonally to each other, which in terms of the invention means that the extensions represent the corner points of an imaginary, i.e., virtual, polygon or polygonal section lying in the plane of the brake disc.

In another feature of the invention, the extensions of the outer ring of the connecting part can exhibit threaded boreholes, wherein each extension exhibits a respective threaded borehole. These threaded boreholes can be used to hold screws for attaching the rim of a wheel to the connecting part, and hence to the brake disc and wheel axle. As an alternative to this configuration, another feature of the invention can also provide that the connecting part be designed as a one-piece component of the wheel rim.

In another feature of the invention, the extensions of the connecting part can exhibit force transmission surfaces, which when assembled abut against the corresponding mating surfaces of the accompanying recesses in the brake disc.

As a result of the structure described above, the contact surfaces between the extensions on the one hand and mating surfaces of the brake discs on the other exhibit optimized minimal dimensions. This advantageously yields only a very few contact points having only very small geometric dimensions between the connecting part and brake disc, thereby improving heat flow within the brake disc, so that the structure according to the invention advantageously helps to minimize deterioration in braking caused by thermal loads.

The connecting part provided by the structure according to the invention is preferably a casting, comprised of a light metal or light metal alloy, for example aluminum, magnesium or the like. The final shape is most preferably imparted to the connecting part via polygonal turning, specifically both in relation to the connecting section to the wheel axle and in terms of the coupling area for the brake disc. Due to its configuration, the connecting part can also be designated as a noncircular or polygonal connector.

In one proposal according to the invention, the wheel is provided with a central attachment. The drive assembly that is supported by a bearing and carries the brake disc as described above continues in a shaft end section that advantageously has a polygonal design. The latter can accommodate a wheel that in turn exhibits a central, corresponding polygonal inner contour. For example, the latter can consist of a steel insert, which is cast into the wheel during its manufacture. Attachment can then take place by screwing on a central fastening nut having a female thread or male thread, which is fixed in place relative to the drive journal. This makes it especially easy to assemble and change out the wheel.

In one proposal according to the invention, the brake disc assembly is itself arranged on the wheel. As a consequence, the structural design of the wheel according to the invention encompasses a central insert, which receives a bearing. The central insert has secured to it both the central attachment of the wheel on the one hand, as well as the brake disc on the other, the latter either directly or indirectly. The central insert can also be integrated into the wheel as a whole as a single piece, for example as steel/steel. If the wheel is made out aluminum and the insert is made out of steel, the latter is additionally inserted, for example simultaneously cast in directly.

The special advantage to the configuration according to the invention also stems from the optimal ventilation of the brake disc, which is vented on both sides. In this way, negative thermal influences are largely avoided. Furthermore, the necessity of additional hub assemblies is avoided. The brake caliper also no longer has to be positioned on intricate equipment so as to float relative to the disc, with the disc instead floating in relation to the drive unit, and automatically positioning itself optimally relative to the brake caliper in every phase during the braking process.

In an advantageous proposal of the invention, the brake caliper is extremely simple in design. It essentially encompasses two half-shells, into which the hydraulic piston and brake pads are placed. In an advantageous proposal of the invention, the half-shells are held together by a power belt. The latter can be a steel belt, but preferably also a CFK belt. This technique further avoids weights, and the half-shells are effectively and easily joined together. When assembling the brake caliper, a shrink fit can be produced via supercooling. In another advantageous proposal of the invention, the hydraulic lines are set up in the brake caliper while fabricating the half-shells, thus eliminating the need for additional lines here as well. The brake caliper is extremely lightweight, and comprised of a minimal number of parts. It can suitably be unilaterally and bilaterally in braking equipment.

In addition to improving functionality, configuring the brake caliper according to the invention also yields a considerable reduction in weight. In particular, no major imbalances, impacts, or similar compensating mechanical suspensions must be provided. The brake caliper according to the invention can basically also be fitted with a unilateral cylinder, so that the counterpart brakes passively. Even given a single-wall structural design, the invention proposes that the power belt be used for load absorption. This enables a weight-optimized structure for the brake caliper. In addition, the brake caliper structure permits the use of noncircular brake cylinders. The latter can be given a large-scale design in the shells, so that considerably less braking pressure is also needed to generate the same braking power. Within the framework of the invention, this can be optimized to where a braking power amplifier is no longer required. The use of noncircular brake cylinders also eliminates the need for a guide, which is necessary in prior art when using round brake cylinders, with the guide fixing the latter against rotation in this way.

A series of inventions and improvements is proposed, which in particular improve the structural design of a wheel assembly in a motor vehicle. Within the meaning of the present invention, a motor vehicle encompasses all vehicles, such as road vehicles, rail cars, and aircraft, but also special vehicles, like agricultural vehicles, construction vehicles and the like.

### BRIEF DESCRIPTION OF THE DRAWINGS

The drawings described herein are for illustrative purposes only of selected embodiments and not all possible implementations, and are not intended to limit the scope of the present disclosure.

Additional features and advantages of the invention may be gleaned from the following description based on the figures. Shown on:

FIG. 1 is the brake disc assembly according to the invention in a first embodiment,

FIG. 2 is the brake disc assembly according to the invention in a second embodiment,

FIG. 3 is a brake caliper according to FIG. 2,

FIG. 4 is a connecting part according to FIG. 1,

FIG. 5 is a connecting part in an alternative configuration,

FIG. 6 is a cross sectional view of the wheel axle according to FIG. 1, and

FIG. 7 is a brake disc.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

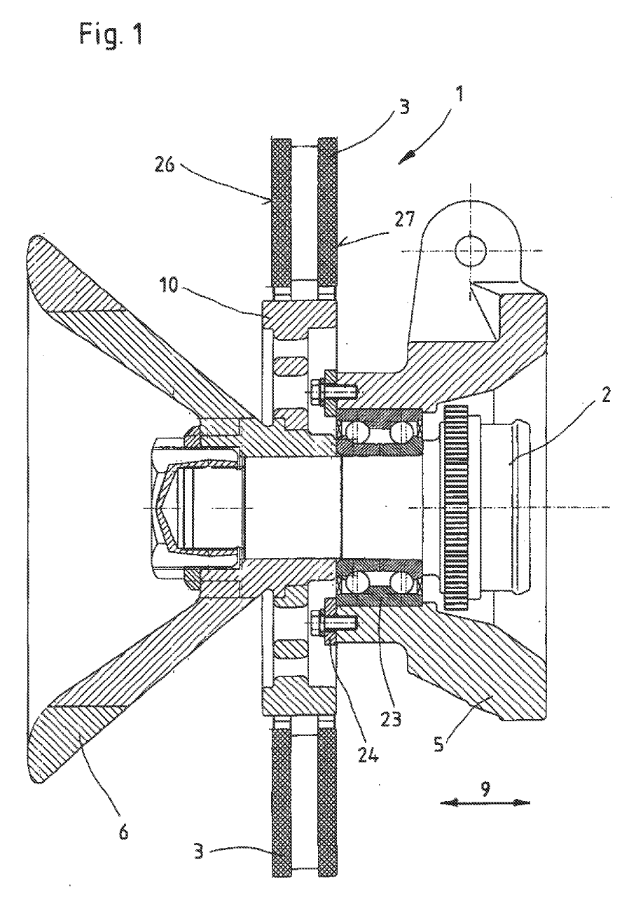

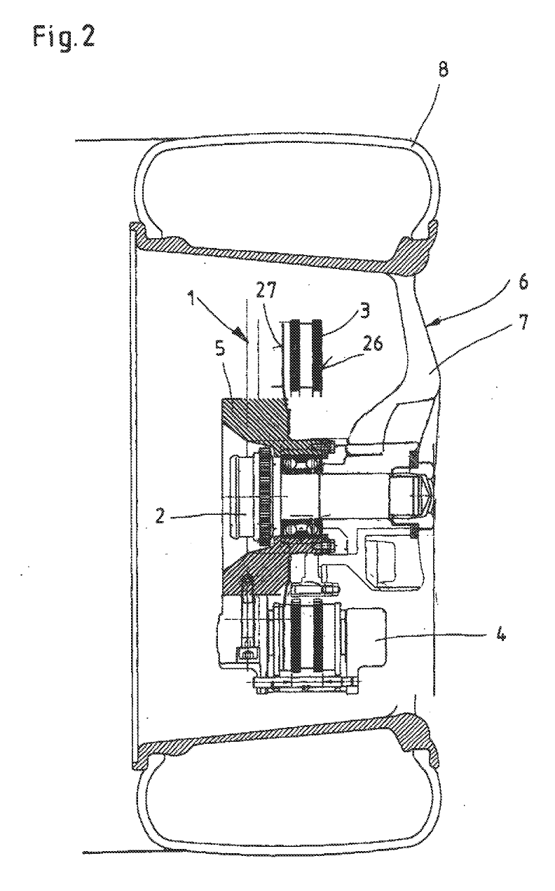

FIG. 1 presents a diagrammatic sectional view of the brake disc assembly 1 according to the invention. The brake disc assembly 1 has a brake disc 3, which in the depicted embodiments according to FIGS. 1 and 2 is designed as a vented brake disc 3.

The brake disc 3 is connected with a wheel axle 2 so as to be fixed against rotation, i.e., it rotates together with the wheel axle 2 when the latter turns.

The wheel axle 2 is held by a wheel carrier 5, wherein one end of the wheel axle 2 is placed in a correspondingly designed recess of the wheel carrier 5, which is sealed by means of a ring cover 24, wherein the ring cover 24 can be joined with the wheel carrier 5 via corresponding screws, as shown on FIGS. 1 and 2. The wheel carrier 5 receives the wheel axle 23, while interspersing a wheel bearing 23, thereby ensuring that the wheel axle 2 can turn relative to the wheel carrier 5.

As may be gleaned from the depiction according to FIG. 2, a brake caliper 4 is arranged on the wheel carrier 5. This brake caliper 4 is designed as a fixed caliper, meaning that it is immovably fixed relative to the brake disc, which turns in conjunction with the wheel axle 2 during operation.

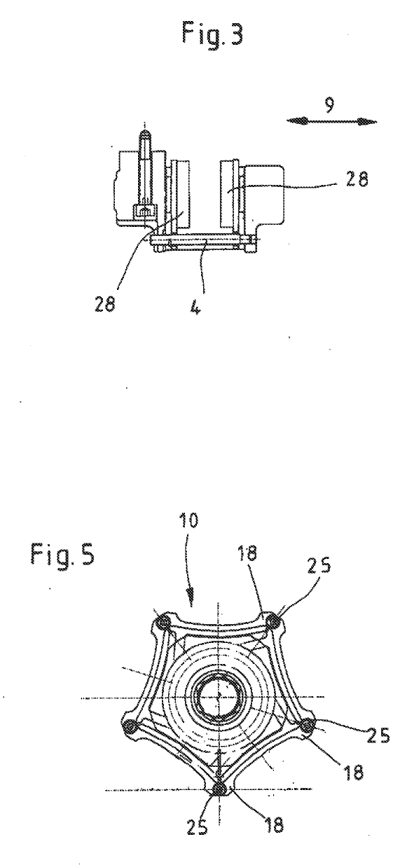

As may be gleaned in particular from the depiction according to FIG. 3, the brake caliper 4 shown on FIG. 2 is one that has two piston-loaded abrasive agent carriers 28. When exposed to an intended load, i.e., in the braking process, the abrasive agent carriers 28 act on the surfaces of the brake disc 3 facing the brake caliper, meaning on the front side 26 of the brake disc 3 on the one hand, and the rear side 27 of the brake disc 3 on the other.

Also connected with the wheel axle 2 so as to be fixed against rotation is a wheel 6, which in the exemplary embodiment shown encompasses a wheel rim 7 and a tire 8 carried by the latter.

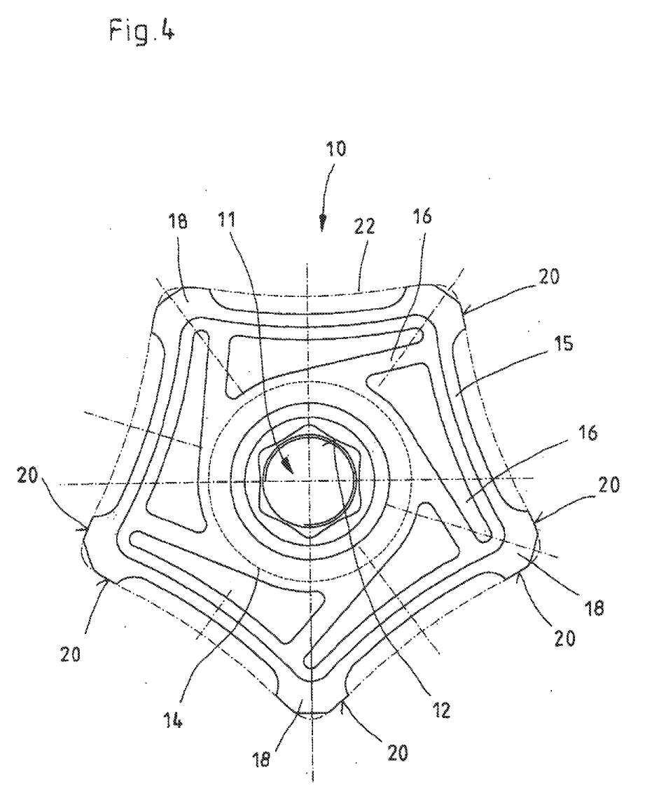

As evident in particular from the depiction according to FIG. 1, the brake disc 3 is connected with the wheel axle 2 so as to be fixed against rotation, with a connecting part 10 interspersed. FIGS. 4 and 5 present a detailed view of such a connecting part 10.

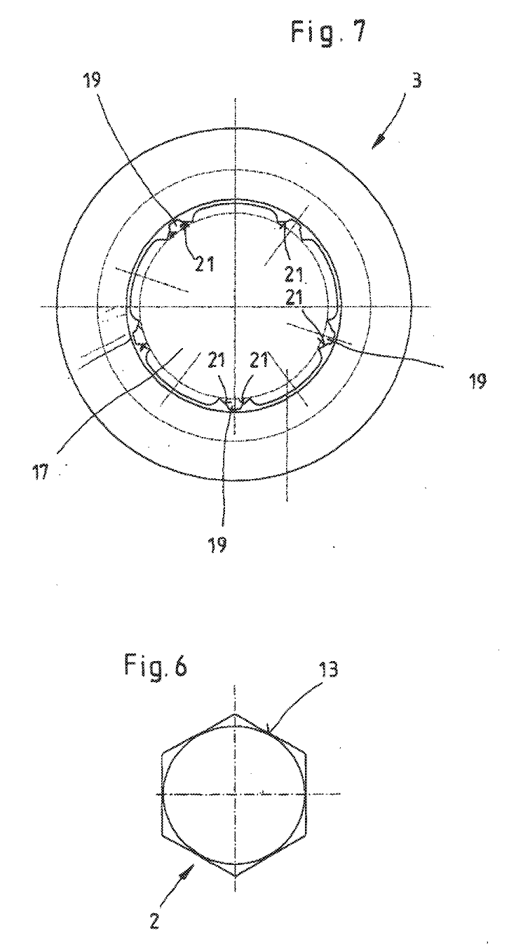

The connecting part 10 has a borehole 11. The inner contour 12 of this borehole 11 is designed to correspond to the cross sectional contour 13 of the wheel axle 2, as evident in particular from an overview of FIGS. 4 and 6. In the exemplary embodiment shown, the inner contour 12 and cross sectional contour 13 are polygonal.

The connecting part 10, also called a polygon connector, has an inner ring 14 that exhibits the borehole 11 described above, and an outer ring 15, wherein the inner ring 14 and outer ring 15 are connected with each other by webs 16. The outer ring 15 of the connecting part 10 has extensions 18 that extend to the outside in relation to the borehole 11. The extensions 18 are here designed in such a way as to represent corner points of an imaginary, i.e., virtual polygon 22.

The brake disc 3 has a central borehole 17, as may be gleaned in particular from the depiction according to FIG. 7. In the assembled state of the brake disc assembly 1, the connecting part 10 is placed in this borehole 17 of the brake disc 3, as may be gleaned from the depiction according to FIG. 1. The extensions 18 of the connecting part 10 here engage into correspondingly designed recesses 19 of the brake disc 3 with the brake disc assembly 1 in an assembled state. Each extension has force transmission surfaces 20, which abut mating surfaces 21 of the recesses 19 of the brake disc 3 in an assembled state.

The brake disc assembly 1 is extremely easy to assemble. The polygonal configuration of the inner borehole 11 makes it easy to slip the connecting part 10 onto the wheel axle 2 designed correspondingly thereto, and then fix it in place. In this case, the polygonal configuration ensures that the wheel axle 2 and connecting part 10 are joined so as to be fixed against rotation. The connecting part 10 can no longer undesirably shift in the longitudinal direction 9 of the wheel axle 2 in relation to the wheel axle 2 after the connecting part 10 has been fixed in place relative to the wheel axle 2, for example by a central locking device. The brake disc can then be slipped onto the connecting part 10. If necessary, the connecting part 10 and brake disc 3 can be preassembled. In terms of the configuration according to the invention, it is crucial that the brake disc 3 be fixed against rotation relative to the wheel axle 2 via the connecting part 10, while still allowing the brake disc 3 to shift in the longitudinal direction 9 of the wheel axle 2, i.e., the brake disc 3 to shift relative to the brake caliper 4 arranged on the wheel carrier 5. According to the invention, this shifting capability is achieved by virtue of the fact that the geometric configuration of the connecting part 10 allows it to positively engage the brake disc 3, whereby the positive fit enables a force transmission in the rotational direction, but not in the longitudinal direction of the wheel axle 2.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A wheel assembly for a motor vehicle, in particular a passenger car, with a brake disc received by a wheel axle so as to be fixed against rotation, and a brake caliper that interacts with the latter, which is constructed as a fixed caliper and arranged on a wheel carrier so as to be fixed with respect to the brake disc, comprising wherein the brake disc is carried by the wheel axle so that it can shift in the longitudinal direction of the wheel axle relative to the brake caliper, wherein, in order to join the brake disc and wheel axle in such a way as to fix them against rotation, a connecting part is provided, wherein the connecting part exhibits a connecting section to the wheel axle and a coupling area for the brake disc, and wherein the connecting section and coupling area are noncircular as the result of polygonal turning.

2. The wheel assembly according to claim 1, wherein the connecting part positively engages both the brake disc and wheel axle.

3. The wheel assembly according to claim 2, wherein the connecting part exhibits a borehole with an inner contour correspondingly designed relative to the cross sectional contour of the wheel axle.

4. The wheel assembly according to claim 3, wherein the cross sectional contour of the wheel axle and inner contour of the borehole of the connecting part are polygonal in design.
